(19) United States
(12) Patent Application Publication
(10) Pub. No.: US 2022/0080497 A1
(43) Pub. Date: Mar. 17, 2022

(54) DECORING HAMMER FOR DECORING CASTINGS AND DECORING MACHINE AND METHOD FOR DECORING A CASTING

(71) Applicant: Fill Gesellschaft m.b.H., Gurten (AT)

(72) Inventor: Alois BOINDECKER, Gurten (AT)

(73) Assignee: Fill Gesellschaft m.b.H., Gurten (AT)

(21) Appl. No.: 17/423,953

(22) PCT Filed: Feb. 11, 2020
(86) PCT No.: PCT/AT2020/060042

§ 371 Date: Jul. 19, 2021

(30) Foreign Application Priority Data
Feb. 11, 2019 (AT) A50103/2019

(51) Int. Cl. B22D 29/00; B25D 17/02; B08B 7/02

(52) U.S. Cl. CPC B22D 29/005; B25D 2222/21; B08B 7/02; B25D 17/02

(57) ABSTRACT

A decoring hammer for decoring cast workpieces, includes: —a housing; —a striker which is coupled to the housing and which includes a contact surface serving for contact on the cast workpiece to be decored. Moreover, a downholder is formed which is coupled to the housing and which includes a downholder surface serving for contact on the cast workpiece to be decored, wherein the striker is displaceable relative to the downholder.

The invention relates to a decoring hammer for decoring cast workpieces.

A decoring hammer for decoring cast workpieces is known from WO2015/189757A1. The decoring hammer comprises a housing, a spindle sleeve and a hammer ram accommodated in the spindle sleeve.

A further decoring hammer is known from WO2014/056014A1.

The decoring hammers known from WO2015/189757A1 and WO2014/056014A1 entail the disadvantage that the core of the workpiece may be removed merely insufficiently.

It was the object of the present invention to overcome the disadvantages of the prior art and to provide a decoring hammer for an improved decoring quality.

This object is achieved by means of a device and a method according to the claims.

According to the invention, a decoring hammer for decoring cast workpieces is formed. The decoring hammer comprises:
a housing;
a striker which is coupled to the housing and which comprises a contact surface serving for contact on the cast workpiece to be decored. Moreover, a downholder is formed which is coupled to the housing and which comprises a downholder surface serving for contact on the cast workpiece to be decored, wherein the striker is displaceable relative to the downholder.

The decoring hammer according to the invention entails the advantage that the cast workpiece may be held in position by means of the downholder and the impact pulses may be applied to the cast workpiece by means of the striker, such that an improved decoring effect may be achieved.

Moreover, it may be useful if the downholder is formed hollow-cylindrically at least in some sections and comprises a central cavity, wherein the striker is accommodated in the cavity. If the downholder is arranged around the striker, this entails the surprising advantage that an improved decoring effect may be achieved. The improved decoring effect may probably be achieved in that due to the arrangement of the downholder, the impact energy may be advantageously introduced into the cast workpiece. In this regard, in a first exemplary embodiment, it may be provided that the downholder is formed hollow-cylindrically. In a further exemplary embodiment, it may be provided that the downholder is not formed to be entirely hollow-cylindrical but that it has interruptions with respect to the circumference such that the striker is accessible.

In a further alternative variant, it may also be provided that the downholder comprises individual segments or pins which are arranged around the striker. These individual segments or pins may be arranged closely to one another around the striker or be spaced apart from one another.

Moreover, it may be provided that the downholder is rigidly coupled to the housing and that the striker is displaceable relative to the housing. A thus designed decoring hammer may have as simple a structure as possible and thus be easy to manufacture and also be less prone to errors.

In addition to this, it may be provided that the striker comprises a striker head and a guide part, wherein a diameter of the striker head is larger than a diameter of the guide part and wherein the cavity of the downholder comprises an offset for the striker head adjoining the downholder surface, wherein a diameter of the offset is larger than the diameter of the striker head. By these measures, a quick and good decoring result may be achieved.

A design, according to which it may be provided that a securing element is formed, by means of which the striker is secured against falling out of the downholder in the longitudinal direction, is also advantageous.

According to the invention, a decoring machine for decoring cast workpieces is formed. The decoring machine comprises:
a machine frame;
a support table for receiving the cast workpiece to be decored,
a decoring hammer.

The decoring hammer comprises the downholder, wherein the downholder of the decoring hammer is displaceable relative to the support table. A decoring machine with a thus designed decoring hammer is particularly suitable for decoring cast workpieces.

Moreover, it may be useful if the decoring machine further comprises the following components:
a machine table which is coupled to the machine frame by means of a suspension, wherein the machine table is mounted so as to be movable relative to the machine frame at least in a main direction of movement by means of the suspension, wherein the workpiece carrier is coupled to the machine table;
a first eccentric mass which is mounted rotatably on the machine table;
a second eccentric mass which is mounted rotatably on the machine table, wherein the second eccentric mass is driven in the opposite direction as the first eccentric mass;
   wherein the workpiece carrier is mounted so as to be rotatable about a horizontal axis of rotation relative to the machine frame.

According to the invention, a method for decoring a cast workpiece, in particular by means of a decoring hammer or by means of a decoring machine, is provided. The method comprises the method steps:
placing a downholder surface of a downholder of the decoring hammer against the cast workpiece;
applying a hold-down force to the cast workpiece by means of the downholder surface of the downholder;
applying impact pulses to the cast workpiece by means of a striker of the decoring hammer.

Moreover, it may be provided that the striker, in addition to the impact pulses, is pressed against the cast workpiece with a striker pressing force, wherein the striker pressing force is lower than the hold-down force of the downholder. This entails the surprising advantage that the cast workpiece is not damaged or is damaged as little as possible in the impact area of the striker.

According to a particular embodiment, it is possible that the hold-down force and/or the striker pressing force are changed depending on the nature of the cast workpiece and/or during the application of the impact pulses to the case workpiece. By this measure, it is possible that the striker pressing force and/or the hold-down force may be adjusted for different cast workpieces such that the best possible decoring result may be achieved. In case of a change of the hold-down force and/or the striker pressing force during the decoring process, an optimal impact may be achieved depending on the decoring progress.

The striker pressing force is the force which is pressed against the cast workpiece with the contact surface of the striker. The striker pressing force is superimposed by the impact pulses of the striker.

In the present document, the main purpose of use of the decoring hammer, namely decoring cast workpieces, is described. However, the person skilled in the art is aware of the fact that the decoring hammer is also suitable for knocking off porous material from any workpiece. Thus, the decoring hammer may also be used, for example, for cleaning workpieces. Such other applications of the decoring hammer are also covered by the scope of protection of the present document.

For the purpose of better understanding of the invention, it will be elucidated in more detail by means of the figures below.

These show in a respectively very simplified schematic representation:

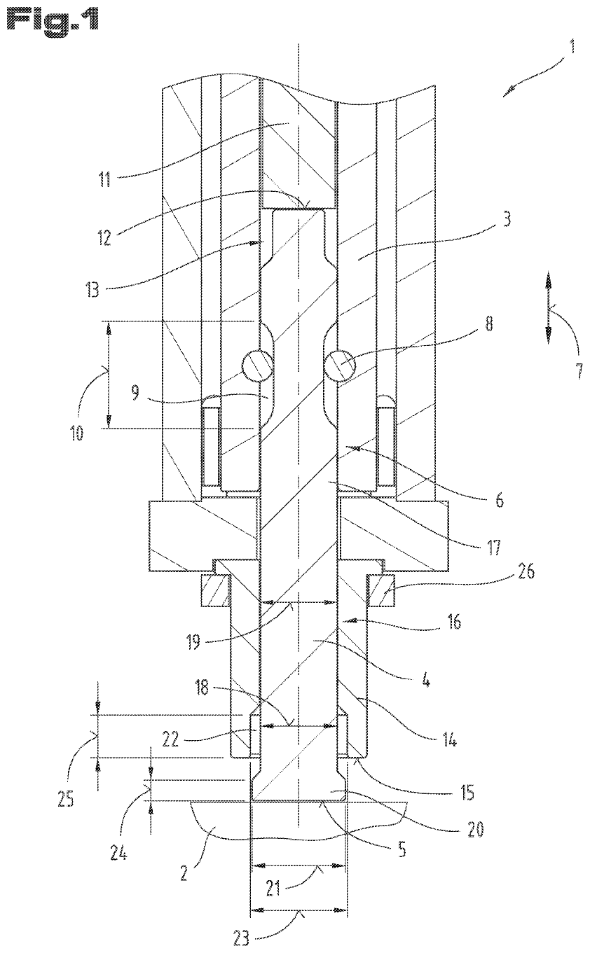

FIG. 1 a cross-sectional view of a first exemplary embodiment of a decoring hammer in a first position;

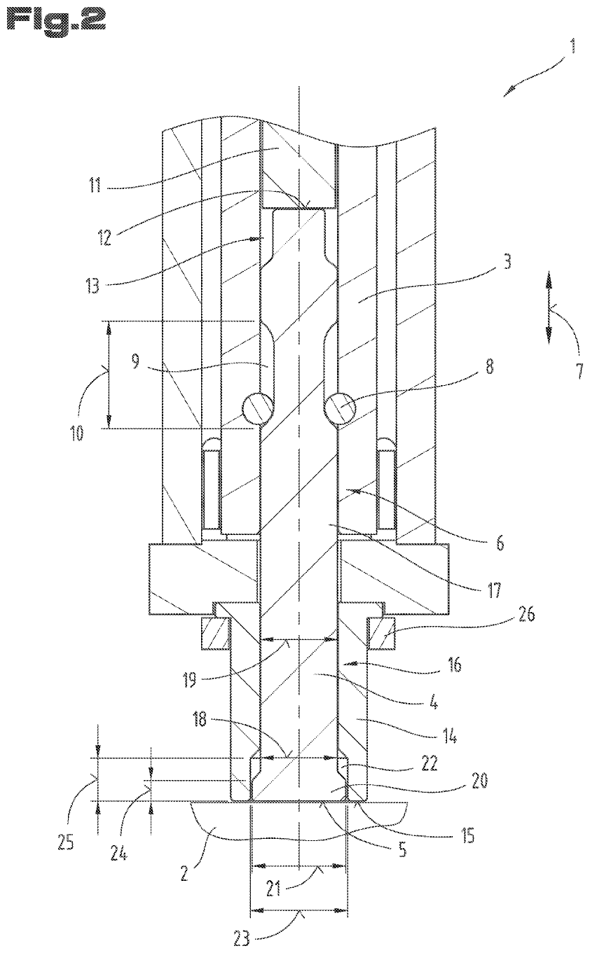

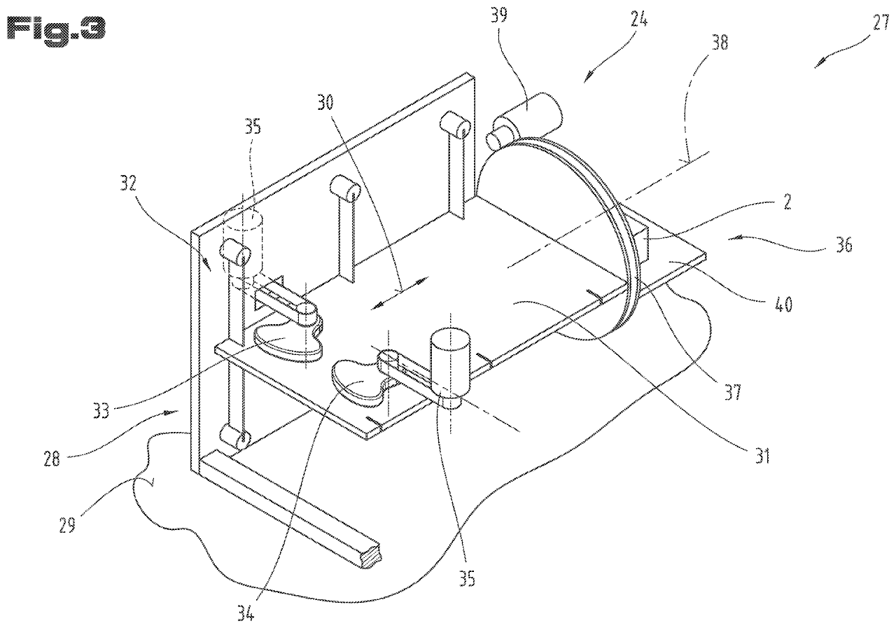

FIG. 2 a cross-sectional view of the decoring hammer in a working position;

FIG. 3 a perspective representation of an exemplary embodiment of a decoring machine;

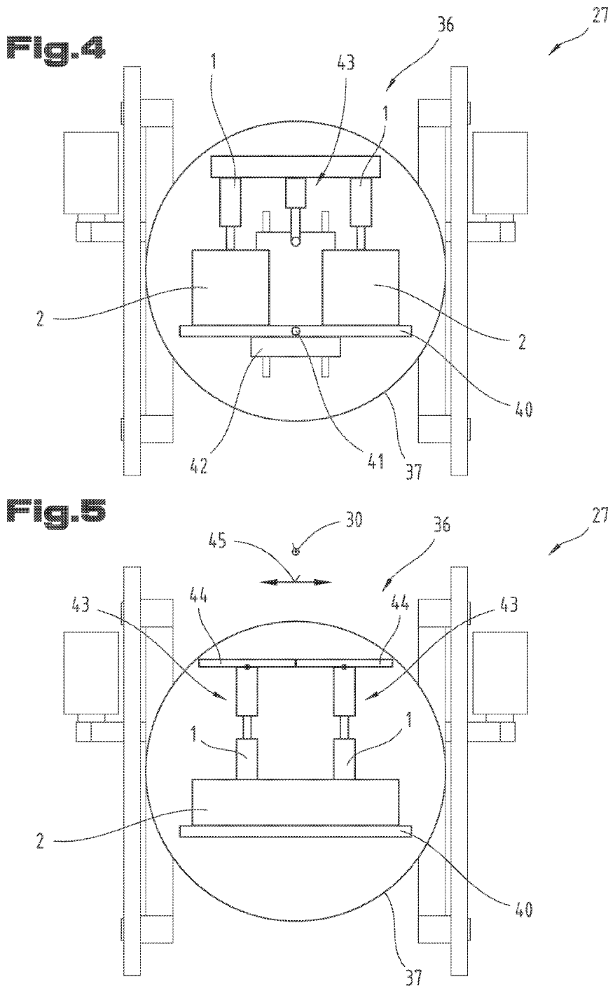

FIG. 4 an outline of a first exemplary embodiment of the decoring machine;

FIG. 5 an outline of a second exemplary embodiment of the decoring machine.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows a half section of a decoring hammer 1 which serves for decoring cast workpieces 2. In particular, the decoring hammer 1 serves for being able to break the sand cores in the cast workpiece 2 by vibration, or to be able to remove sand residues from the cast workpiece 2.

As can be seen from FIG. 1, the decoring hammer 1 comprises a housing 3 which forms the basis of the decoring hammer 1 and serves for receiving further mounting parts.

Moreover, it may be provided that a striker 4, which serves for contact with the cast workpiece 2 to be decored, is arranged in the housing 3. In particular, it is provided that during the decoring process, a contact surface 5 of the striker 4 is in contact with the cast workpiece 2 to be decored.

As can be seen from FIG. 1, it may be provided that the striker 4 is displaceably held in a striker receptacle 6 in the housing 3 in a longitudinal direction 7 of the decoring hammer 1. In this regard, the striker 4 is held such in the striker receptacle 6 that the contact surface 5 of the striker 4 is located outside of the housing 3 and may be brought into contact with the cast workpiece 2.

Moreover, it may be provided that a securing element 8 is formed, by means of which the striker 4 may be secured against falling out of the striker receptacle 6. Moreover, it may be provided that a securing recess 9, which cooperates with the securing element 8, is formed in the striker 4, wherein the securing recess 9 has a longitudinal extent 10 which is measured such that the striker 4 can move freely in the striker receptacle 6.

Moreover, it may be provided that a striking piston 11 is formed which serves for applying the impact energy to the striker 4. In particular, it may be provided that the striking piston 11 is formed for periodically impacting on a striking piston surface 12 of the striker 4, whereby the impact pulse may be introduced into the striker 4. The striking piston 11 may, for example, be driven by means of an electric motor or pneumatically or hydraulically.

Moreover, it may be provided that the striker 4 has a taper 13 in the region of the striking piston surface 12. The taper 13 serves for accommodating any deformation of the striker piston surface 12 of the striker 4 without causing the striker 4 to seize in the striker receptacle 6.

Moreover, a downholder 14 is formed which comprises a downholder surface 15 which also serves for contact with the cast workpiece 2. In the first exemplary embodiment according to FIG. 1, it is provided that the downholder 14 is rigidly coupled to the housing 3.

In an alternative exemplary embodiment, which is not shown, it may also be provided that the downholder 14 is displaceable relative to the housing 3 by means of an actuator. Such an actuator may, for example, be a pneumatic cylinder or a hydraulic cylinder.

In yet another exemplary embodiment, which is not shown, it may be provided that the downholder 14 is spring-loadedly displaceable relative to the housing 3, such that a pressing force of the downholder 14 on the cast workpiece 2 is determined by the spring force. In this regard, the spring may for example be an elastic component, such as a coil spring or a gas spring.

As can be seen from FIG. 1, it may be provided that the downholder 14 has a cavity 16 in which the striker 4 is accommodated.

Moreover, it may be provided that the striker 4 has a guide part 17 by means of which the striker 4 is guided in the striker receptacle 6. The guide part 17 of the striker 4 has a diameter 18. Moreover, it is provided that an inner diameter 19 of the cavity 16 of the downholder 14 is larger than the diameter 18 of the guide part 17. Moreover, it may be provided that the striker 4 has a striker head 20 on which the contact surface 5 of the striker 4 is formed. A diameter 21 of the striker head 20 is larger than the diameter 18 of the guide part 17. Moreover, it may be provided that an offset 22, which serves for receiving the striker head 20, is formed in the downholder 14. A diameter 23 of the offset 22 is larger than the diameter 21 of the striker head 20. The striker head 20 moreover has a height 24 which is smaller than a height 25 of the offset 22. By the described design, the striker 4 may move relative to the downholder 14 in the operating state so as to be able to apply impact energy onto the cast workpiece 2.

As can be seen from FIG. 1, it may be provided that the downholder 14 is mounted on the housing 3 by means of a mounting means 26.

FIG. 1 shows the decoring hammer 1 in a contact position, wherein merely the contact surface 5 of the striker 4 is in contact with the cast workpiece 2. To transfer the decoring hammer 1 to its working position, it is displaced in the longitudinal direction 7 to the cast workpiece 2 so that the downholder surface 15 of the downholder 14 is also in contact with the cast workpiece 2. This working position is shown in FIG. 2.

FIG. 3 shows a first exemplary embodiment of a decoring machine 27, which may also be referred to as vibrating machine, in an oblique view. The decoring machine 27 serves for removing the cores from cast workpieces 2. The decoring machine 27 comprises a machine frame 28 which can be set up or is set up on a machine base 29. Moreover, the decoring machine 27 comprises a machine table 31, which is mounted so as to be movable in a main direction of movement 30 with respect to the machine frame 28, for spanning the cast workpiece 2. In this regard, the machine table 31 is movably mounted on the machine frame 28 by means of a suspension 32.

Moreover, the decoring machine 1 comprises a first eccentric mass 33 which is rotatably mounted on the machine table 31.

In addition to this, the decoring machine 1, in the present exemplary embodiment, comprises a second eccentric mass 34 which is rotatably mounted on the machine table 31. The second eccentric mass 34 is driven in the opposite direction as the first eccentric mass 33.

In the present exemplary embodiment, the first eccentric mass 33 and the second eccentric mass 34 are coupled with an eccentric drive motor 35.

In the present exemplary embodiment, the two eccentric masses 33, 34 may each be driven independently by the respectively assigned eccentric drive motor 35. In this regard, the two eccentric drive motors 35 may be controlled such that the eccentric masses 33, 34 are rotated synchronized to each other in opposite directions of rotation.

As can further be seen from FIG. 3, it may be provided that a workpiece carrier 36 for receiving the cast workpiece 2 is provided. The workpiece carrier 36 may be mounted so as to be rotatable about a horizontal axis of rotation 38 relative to the machine table 31 by means of a pivot bearing 37. In this regard, the horizontal axis of rotation 38 may be arranged in parallel to the main direction of movement 30.

Due to the pivoting capability of the workpiece carrier 36, the cast workpiece 2 may be turned upside down and/or pivoted sideways such that the molding sand in the cast workpiece 2 may be removed from the cast workpiece 2 by the action of gravity.

As can be seen from FIG. 3, during the operation of the decoring machine 1, the machine table 31 is caused to oscillate in the main direction of movement 30 by the eccentric masses 33, 34. This relative movement between the machine table 31 and the machine frame 28 may be achieved by the flexible suspension 32 of the machine table 31.

In particular, it may be provided that the machine table 31 oscillated with an amplitude between +/−2 mm and +/−15 mm. An amplitude between +/−4 mm and +/−8 mm has proven advantageous.

Since the workpiece carrier 36 is coupled to the machine table 31 by means of the pivot bearing 37, the workpiece carrier 36 oscillates with the machine table 31 in the same amplitude. The pivot bearing 37, as the connecting component between the machine table 31 and the workpiece carrier 36, thus, of course, also oscillates in the main direction of movement 30.

Moreover, a rotary drive 39, which serves for rotating the workpiece carrier 36 relative to the machine table 31, is shown in schematic manner.

FIG. 4 shows a schematic front view of the decoring machine 1, wherein a possible application example of the decoring hammers 1 according to the invention is shown.

As can be seen from FIG. 4, it may be provided that the workpiece carrier 36 comprises a support table 40 which the cast workpiece(s) 2 are supported on.

Moreover, it may be provided that the support table 40 is tiltably arranged on a base rack 42 by means of a self-aligning bearing 41. This is particularly advantageous where two decoring hammers 1 are formed. By this measure, two cast workpieces 2 may be mounted on the support table 40, wherein due to the self-aligning bearing 41 the clamping force may be distributed to both cast workpieces 2.

Moreover, it may be provided that an infeed cylinder 43 is formed, by means of which the support table 40 may be displaced relative to the decoring hammers 1. By these measures, cast workpieces 2 of different heights may be spanned in the workpiece carrier 36.

In particular, it may be provided that, by means of the infeed cylinder 43, the decoring hammers 1 may be pressed against the cast workpiece 2 such that the downholder 14 is in contact with the cast workpiece 2. Thus, it may be provided that the hold-down force, by means of which the downholder surface 15 of the downholder 14 is applied to the cast workpiece 2, is determined by the infeed cylinder 43.

In a first exemplary embodiment, as can be seen from FIG. 4, it may be provided that the base rack 42 of the workpiece carrier 36 is displaceable relative to the pivot bearing 37, whereby the infeed of the decoring hammer 1 to the workpiece 2 is achieved. In this regard, in particular, the workpiece 2 which are accommodated on the support table 40 are displaced towards the decoring hammer 1.

FIG. 5 shows a further exemplary embodiment of the front view.

As can be seen from FIG. 5, it may be provided that the support table 40 is rigidly accommodated at the pivot bearing 37 and that the decoring hammer 1 in its entirety is displaceable relative to the support table 40 by means of the infeed cylinder 43, whereby the decoring hammer 1 can be brought into engagement with the cast workpiece 2.

As can be seen from FIG. 5, it may be provided that two or multiple decoring hammers 1 are formed which each have their own infeed cylinder 43. By this measure, the hold-down force, which is applied to the cast workpiece 2 by the downholder 14, may be set for each one of the decoring hammers 1 individually and independently of the further decoring hammers 1.

Moreover, a guide rail system 44 may be formed by means of which the decoring hammer 1 or the decoring hammers 1 may be adjusted relative to the support table 40 in the main direction of movement 30 and/or in a transverse direction 45. In particular, it may be provided that the decoring hammers 1 can be adjusted individually and independently of one another.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the teaching for technical action provided by the present invention lies within the ability of the person skilled in the art in this technical field.

The scope of protection is determined by the claims. However, the description and the drawings are to be adduced for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

List of reference numbers

| | |
|---|---|
| 1 | Decoring hammer |
| 2 | Cast workpiece |
| 3 | Housing |
| 4 | Striker |
| 5 | Contact surface of striker |
| 6 | Striker receptacle |
| 7 | Longitudinal direction |
| 8 | Securing element |
| 9 | Securing recess |
| 10 | Longitudinal extent |
| | of securing recess |
| 11 | Striking piston |
| 12 | Striking piston surface of striker |
| 13 | Taper of striker |
| 14 | Downholder |
| 15 | Downholder surface |
| 16 | Cavity of downholder |
| 17 | Guide part of striker |
| 18 | Diameter of guide part |
| 19 | Inner diameter of cavity |
| 20 | Striker head |
| 21 | Diameter of striker head |
| 22 | Offset |
| 23 | Diameter of offset |
| 24 | Height of striker head |
| 25 | Height of offset |
| 26 | Mounting means |
| 27 | Decoring machine |
| 28 | Machine frame |
| 29 | Machine base |
| 30 | Main direction of movement |
| 31 | Machine table |
| 32 | Suspension |
| 33 | First eccentric mass |
| 34 | Second eccentric mass |
| 35 | Eccentric drive motor |
| 36 | Workpiece carrier |
| 37 | Pivot bearing |
| 38 | Horizontal axis of rotation |
| 39 | Rotary drive |
| 40 | Support table |
| 41 | Self-aligning bearing |
| 42 | Base rack |
| 43 | Infeed cylinder |
| 44 | Guide rail system |
| 45 | Transverse direction |

1. A decoring hammer for decoring cast workpieces comprising:
a housing;
a striker which is coupled to the housing and which comprises a contact surface serving for contact on the cast workpiece to be decored;
wherein
a downholder is formed which is coupled to the housing and which comprises a downholder surface serving for contact on the cast workpiece to be decored, wherein the striker is displaceable relative to the downholder.

2. The decoring hammer according to claim 1, wherein the downholder is formed hollow-cylindrically at least in some sections and comprises a central cavity, wherein the striker is accommodated in the cavity.

3. The decoring hammer according to claim 1, wherein the downholder is rigidly coupled to the housing and wherein the striker is displaceable relative to the housing.

4. The decoring hammer according to claim 2, wherein the striker comprises a striker head and a guide part, wherein a diameter of the striker head is larger than a diameter of the guide part and wherein the cavity of the downholder comprises an offset for the striker head adjoining the downholder surface wherein a diameter of the offset is larger than the diameter of the striker head.

5. The decoring hammer according to claim 2, wherein a securing element is formed, by means of which the striker is secured against falling out of the downholder in the longitudinal direction.

6. A decoring machine for decoring cast workpieces comprising:
a machine frame;
a support table for receiving the cast workpiece to be decored,
a decoring hammer
wherein
the decoring hammer is designed according to claim 1 and wherein a downholder of the decoring hammer is displaceable relative to the support table.

7. The decoring machine according to claim 6, wherein the decoring machine further comprises the following components:
a machine table which is coupled to the machine frame by means of a suspension, wherein the machine table is mounted so as to be movable relative to the machine frame at least in a main direction of movement by means of the suspension, wherein the workpiece carrier is coupled to the machine table;
a first eccentric mass which is mounted rotatably on the machine table;
a second eccentric mass which is mounted rotatably on the machine table, wherein the second eccentric mass is driven in the opposite direction as the first eccentric mass;
wherein the workpiece carrier is mounted so as to be rotatable about a horizontal axis of rotation relative to the machine frame.

8. A method for decoring a cast workpiece by means of the decoring hammer according to claim 1 or by means of a decoring machine, the method comprising the following method steps:
placing a downholder surface of a downholder of the decoring hammer against the cast workpiece;
applying a hold-down force to the cast workpiece by means of the downholder surface of the downholder;
applying impact pulses to the cast workpiece by means of a striker of the decoring hammer.

9. The method according to claim 8, wherein the striker, in addition to the impact pulses, is pressed against the cast workpiece with a striker pressing force, wherein the striker pressing force is lower than the hold-down force of the downholder.

10. The method according to claim 8, wherein the hold-down force and/or the striker pressing force are changed depending on the nature of the cast workpiece and/or during the application of the impact pulses to the case workpiece.
